(19) United States
(12) Patent Application Publication
(10) Pub. No.: US 2013/0088393 A1
(43) Pub. Date: Apr. 11, 2013

(54) TRANSMIT AND RECEIVE PHASED ARRAY FOR AUTOMOTIVE RADAR IMPROVEMENT

(71) Applicants: Jae Seung Lee, Ann Arbor, MI (US); Paul Donald Schmalenberg, Ann Arbor, MI (US)

(72) Inventors: Jae Seung Lee, Ann Arbor, MI (US); Paul Donald Schmalenberg, Ann Arbor, MI (US)

(73) Assignee: Toyota Motor Engineering & Manufacturing North America, Inc., Erlanger, KY (US)

(21) Appl. No.: 13/267,546

(22) Filed: Oct. 6, 2011

(51) Int. Cl. H01Q 3/00

(52) U.S. Cl. 342/372

(57) ABSTRACT

Examples of the present invention include methods and apparatus for phased array automotive radar which allow reductions in erroneous detections such as sidelobe clutter and ghost images. An example radar includes a steerable transmit antenna and a steerable receive antenna. Transmit and receive beams may be steered using an electronic control circuit so the main lobe of the transmit beam remains generally aligned with the main lobe of the receive beam, and the side lobe of the receive beam remains generally aligned with a null in the transmit beam.

### FIELD OF THE INVENTION

The invention includes apparatus and methods for improved automotive radar, in particular phased array radar.

### BACKGROUND OF THE INVENTION

Many current automotive radars use digital beam forming (DBF) to determine the bearing of a target. DBF uses antennas with wide beams, which causes the reception of unwanted signals. The effect is to increase overall noise, and to create difficulties with false target detection.

Hence, it would be very valuable to develop improved automotive radars, which allow reduction in false target detection while being capable of low cost fabrication for automotive applications.

### SUMMARY OF THE INVENTION

Examples of the present invention include phased array radars for use in automotive applications. An example apparatus includes a transmit antenna array, a receive antenna array, a transmit chip in electronic communication with the transmit antenna array, and a receiver chip in electronic communication with the receive antenna array. Separating the transmit and receive antennas reduces coupling between the transmit and receive channels, and allows reduced chip complexity. The transmit chip provides a local oscillator signal to the receive chip, for phased array detection. An example apparatus includes a circuit board supporting separate transmit and receive antenna arrays, each array having an associated chip.

In examples of the present invention, the receive antenna elements have a spacing much greater than one half operating wavelength, but are close enough to avoid grating lobes at straight bore sight. This configuration increases gain, but generates grating lobes at angles to the straight bore sight when the beam is steered. However, the effect of grating lobes is minimized by steering the transmit phased array so that a null in the transmit antenna pattern (the transmit beam) generally coincides with the corresponding incoming angle of the grating lobe generated by the receive antenna. Increasing the receive antenna gain narrows the antenna beam, allowing higher signal-to-noise ratios.

In example antennas, the transmit antenna array is in electronic communication with a transmit chip that includes a phased array control, variable gain control, an oscillator, and a phase locked loop. The receive antenna array is in electronic communication with a receive chip that includes a phased array control, variable gain control, and a mixer. The transmit and receive chips are connected by a local oscillator feed line. Example antennas are configured so that FMCW (frequency modulated continuous-wave) operations can be performed.

### BRIEF DESCRIPTION OF THE FIGURES

FIG. 1 is a schematic of an antenna configuration.

FIG. 2 (prior art) illustrates the operation of a DBF radar.

FIG. 3 illustrates a beam created by either receive or transmit beam steering radar.

FIG. 4 shows a receive antenna pattern, including the main lobe at the steering angle, and a grating lobe.

FIG. 5 shows the transmit antenna pattern, in which the transmit pattern includes a null at an angle corresponding to the grating lobe in the receive antenna pattern.

FIG. 6 illustrates the combined system sensitivity, showing the transmit pattern, receive pattern, and the combined signal formed by multiplication thereof.

FIG. 7 illustrates a radar return power distribution where only the receiver includes a phased array, including ghost targets due to the grating lobe.

FIG. 8 shows a radar pattern for transmit and received phased array operation, illustrating that the ghost targets are eliminated and side lobe clutter is greatly reduced.

### DETAILED DESCRIPTION OF THE PREFERRED EMBODIMENTS

Examples of the present invention include apparatus and methods that improve automotive radar performance, particularly by reducing noise levels and eliminating ghost targets. Example radar apparatus include phased array beam scanning on both transmit and receive portions of the radar architecture.

Example radar apparatus have a transmit-receive phased array architecture that requires only two control chips mounted onto an antenna board. The improved configuration provides a reduction in overall noise level, resulting in significant improvement of target discrimination. The problem of ghost targets is reduced, for example by reduction of multipath reflections. Further, the radar manufacturing process is relatively simple, and may be fabricated with low cost and complexity.

An example phased array radar apparatus includes a transmit antenna array, a receive antenna array, and an electronic control circuit, in electronic communication with the transmit and receive antenna arrays. The transmit beam, generated by the transmit array, and the receive beam, received by the receive array, are each steerable by the electronic control circuit so the main lobe of the transmit beam remains generally aligned with the main lobe of the receive beam, and the grating lobe of the receive beam remains generally aligned with a null in the transmit beam. A null may also be referred to as a node in the angular response. In this way erroneous detection signals, in particular ghost images resulting from the grating lobe, may be significantly reduced.

An electronic control circuit may include physically separate transmit and receive chips, electrically connected by a local oscillator feedline to allow phased array detection. Examples of the invention include the attachment of small phase shifting chips to the antenna substrate. This allows the combination of a phased array transmit and phased array receive antenna within the same radar apparatus, at a cost feasible for consumer and automated applications. An example receive antenna array includes many more channels (and antenna elements) than the transmit antenna array. An apparatus may comprise a housing including a substrate, with antenna elements, a transmit chip, a receive chip, and electrical interconnections between the chips and antenna element disposed on the substrate. The substrate may include a planar dielectric material.

In some examples, the receive antenna has an antenna pitch (antenna element spacing, center-to-center) that is greater than half the antenna operating wavelength, for example ≦0.6 λ, where λ is the operating wavelength. Expanding the receive antenna pitch increases the antenna gain and narrows the main lobe of the receive beam, which increases resolution. However, the increased antenna pitch may also generate a grating lobe, in which the sensitivity of the antenna increases along a side lobe direction that is angularly offset from the target direction (the intended direction of the receive beam). The grating lobe allows a significant level of erroneous signals to be received, degrading the antenna response. However, with the electronically controlled angular alignment of the grating lobe with a transmit beam null, these erroneous signals can be greatly reduced. In examples of the present invention, the advantages of enhanced gain and narrowed main lobe are obtained without the problems associated with grating lobe formation. The grating lobe is not eliminated from the receive beam, but by greatly reducing the transmit beam power along the grating lobe direction, the level of erroneous signals is greatly reduced.

In some examples, the receive antenna pitch is greater than 0.5 and less than or equal to 1.5 times the receive antenna operating wavelength (λ), for example in the range 0.6 λ-1.5 λ, such as within the range 0.7 λ-1.3 λ. Example ranges are inclusive.

In some examples, the receive antenna array may have at least 4 times as many antenna elements than the transmit antenna array, in some cases more than 8 times the number of elements (sometimes referred to as channels). For example, the transmit antenna may have 4 or 8 elements, and the receive antenna may have 64 or 128 elements.

The transmit beam and the receive beam may be steered by the electronic control circuit so the side lobe (here, the grating lobe) of the receive beam is aligned within 10 degrees, such as within 5 degrees, of the null in the transmit beam. Exact alignment may not be necessary, as long as the transmit beam has greatly reduced power along the grating lobe, as compared to along the receive beam main lobe.

The main lobes of the transmit and receive beams also remain aligned as the beams scan the environment of the radar. In some examples, particularly with a relatively small number of transmit antenna elements, the transmit main lobe may have a broad high power region, so that as long as the transmit and receive main lobes are aligned within 10°, excellent performance is obtained.

The power of the transmit beam can be much greater along the receive beam direction (the center of the receive main lobe) than along the grating lobe direction. For example, if the peak power of the transmit main lobe is 0 dB, the normalized transmit power along the receive beam may be greater than −10 dB, such as greater than −5 dB. The normalized transmit power along the grating lobe direction may be less than −30 dB, such as less than −40 dB, and in some cases less than −50 dB.

In some cases, the null is much narrower (in terms of angular width) than the main lobe of the transmit beam. In that case, close alignment of the null with the grating lobe may be more important (in terms of radar performance improvement) than the alignment of the receive main lobe with the relatively broad transmit main lobe. Hence, the antenna may be configured so that the null is closely aligned with the grating lobe (e.g. within 5°, such as within 3°), and the receive main lobe is located within the relatively broad transmit main lobe.

A method of operating a phased array automotive radar to reduce erroneous detections includes providing a steerable transmit antenna and generating a transmit beam having a main transmit lobe and a transmit null, providing a steerable receive antenna, receiving a receive beam having a main receive lobe and a grating lobe, and steering the transmit beam and the receive beam using an electronic control circuit so that the grating lobe of the receive beam remains generally aligned with the null in the transmit beam as the beams are swept together across the field of view. In example apparatus, the field of view may be approximately equal to or greater than 45°, in some examples ≧75°. The main lobe of the transmit beam remains generally aligned with the main lobe of the receive beam as the beams are steered.

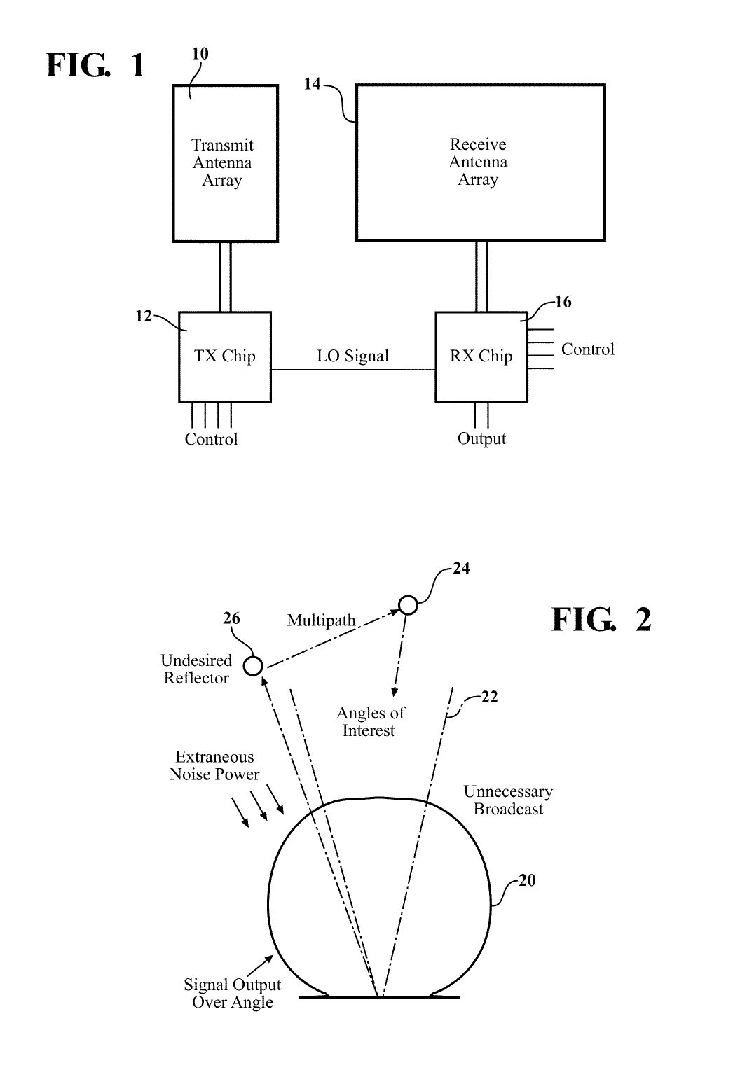

FIG. 1 is a schematic of an example radar apparatus, including transmit antenna array 10, transmit chip 12, receive antenna array 14, and receive chip 16. The transmit antenna 10 is in electrical communication with the transmit chip 10, and the receive antenna 14 is electrical communication with the receive chip 16. The line labeled “LO signal” corresponds to the local oscillator feed line from the transmit chip to receive chip.

Two sets of antenna elements may be printed onto the same circuit board. One antenna is for transmit, and the other antenna is for receive. By separating the antennas on the board, the amount of unwanted coupling from transmit to receive channels is reduced. The separation also allows a reduction in chip complexity.

In examples of the present invention, the receive antenna elements are spaced far more than one half of the operating wavelength, for example greater than 0.6 λ, increasing gain but generating grating lobes when the beam is steered. Preferably, the receive antenna elements are close enough together that grating lobes at straight bore sights are avoided. This allows the effect of the grating lobes to be largely eliminated using characteristics of the transmit beam. The transmit beam is steered so that a null in the transmit antenna pattern (the transmit beam) coincides with the incoming angle of the grating lobe generated by the receive antenna. Hence the overall system response, correlated with the multiplication of transmit and receive angular profiles, reduces response of the grating lobe.

The increased receive antenna element spacing (pitch) allows a higher gain of the receive antenna, and further allows a narrower antenna beam. This allows higher signal-to-noise ratios, and the transmit phased array also contributes by lowering the side lobe levels of the receiver pattern.

For example, the transmit chip may include a phased array control, variable gain control, an oscillator, and a phase locked loop. The LO signal conveys a portion of the oscillator signal to the received chip. Similarly, the receive chip may includes a phased array control, variable gain control, and a mixer. This configuration allows FMCW operations to be performed.

An improved configuration includes phased array steering of both the transmit beam and the receive beam. Separation of the antennas allows simpler chip configurations to be used, and further reduces unwanted coupling between transmit and receive channels. Further, the transmit and receive array steering can be controlled so that the grating lobe of the receiver antenna corresponds to a null in the transmit beam intensity.

FIG. 2 (prior art) shows an output pattern for a DBF radar, a radar with only receive beam steering. The figure shows the signal output (transmit beam) 20 as being a wide beam, which directs extraneous noise power into angles that are not of interest. Further, the wide angle transmit signal output may create ghost images, for example the illustrated multipath situation, with the undesired reflector 26 reflecting transmit power to object of interest 24, which then is reflected back to the receiver. The angles of interest are delineated by dashed lines such as 22.

Signal processing may be used to create high resolution azimuth delineation, but noise power is integrated with the desired signal due to the wide angle power transmission. Ghost targets also appear if a strong multipath situation occurs. As can be seen in this configuration, transmit power is unnecessarily broadcast into regions outside the angles of interest. This increases both noise and multipath reflection problems.

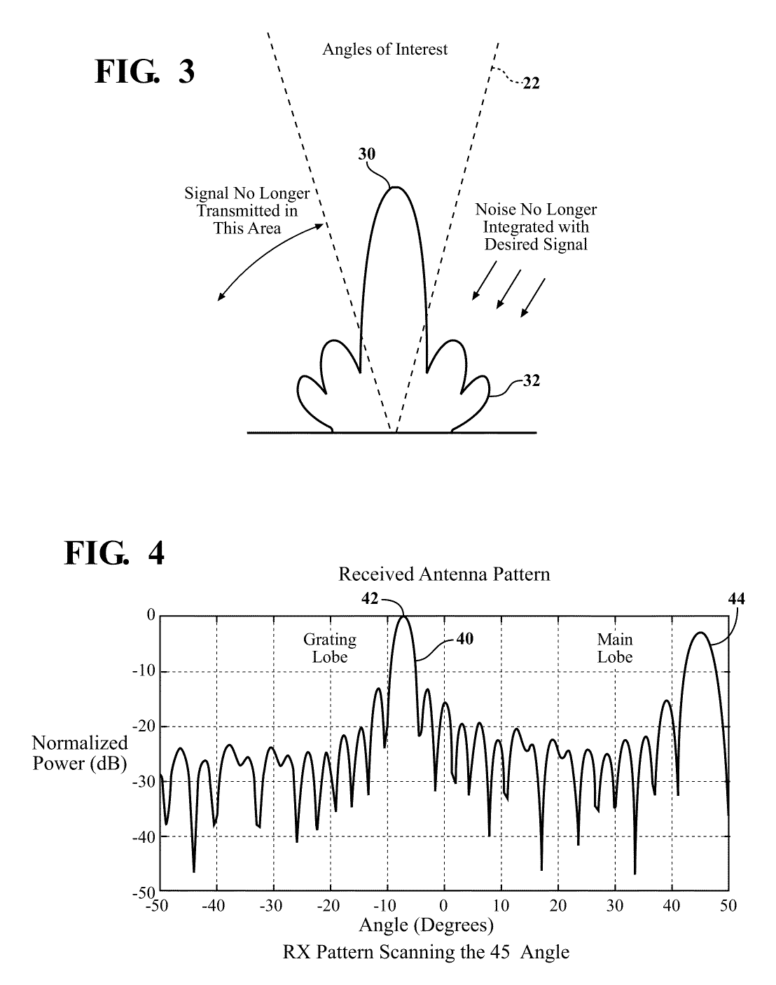

FIG. 3 shows a beam created by either receive or transmit beam steering radar. The beam is created by the hardware, rather than a rotatable antenna, and so there is physically less noise arriving at the antenna aperture and multipath reflections are attenuated considerably. This is also due to the low side lobe levels of this particular method. The field of view is maintained because of the beam steering capability.

FIG. 3 shows an example transmit (or receive) beam 30 with power concentrated within the angles of interest delineated by dashed line 22. As noise is no longer integrated with the desired signal, because of the much reduced extraneous and unnecessary broadcast power into regions outside the angles of interest. In some examples, the receive beam may have a similar profile.

The angles of interest are delineated by dashed lines such as 22, and these may be scanned with received beam steering. The angles of interest generally correspond to the field of view of the antenna, achieved by scanning the transmit and receive beam across the field of view. In some examples, the transmit and/or receive beam may be much narrower than illustrated in FIG. 3.

The received signal of the radar system is the product of the patterns generated by the transmit and receive antenna arrays. By spacing out the elements of the receive array, for example beyond λ/2 (e.g. antenna pitch >0.6 λ) the antenna beam performance is improved, especially the gain and angular beam width. This approach may be used with either or both the transmit or receive beams.

In examples below, the example of a receive antenna having increased element spacing (beyond λ/2) is discussed. However, this increased spacing also generates grating lobes. Using a dual phased array antenna, the transmit array can be controlled so as to eliminate the effects of receive array unwanted lobes.

FIG. 4 shows an example receiver antenna pattern 40. The main lobe 44 is at directed an angle of approximately 45 degrees. However, there is also a grating lobe 42 at an angle of approximately −6 degrees. In this example, 0 degrees is the straight on direction, and the normalized power ordinates are shown in decibels which tends to compress the curve. With an unsteered transmit antenna, such as an omnidirectional transmit antenna, the grating lobe would create various problems, such as spurious reflections.

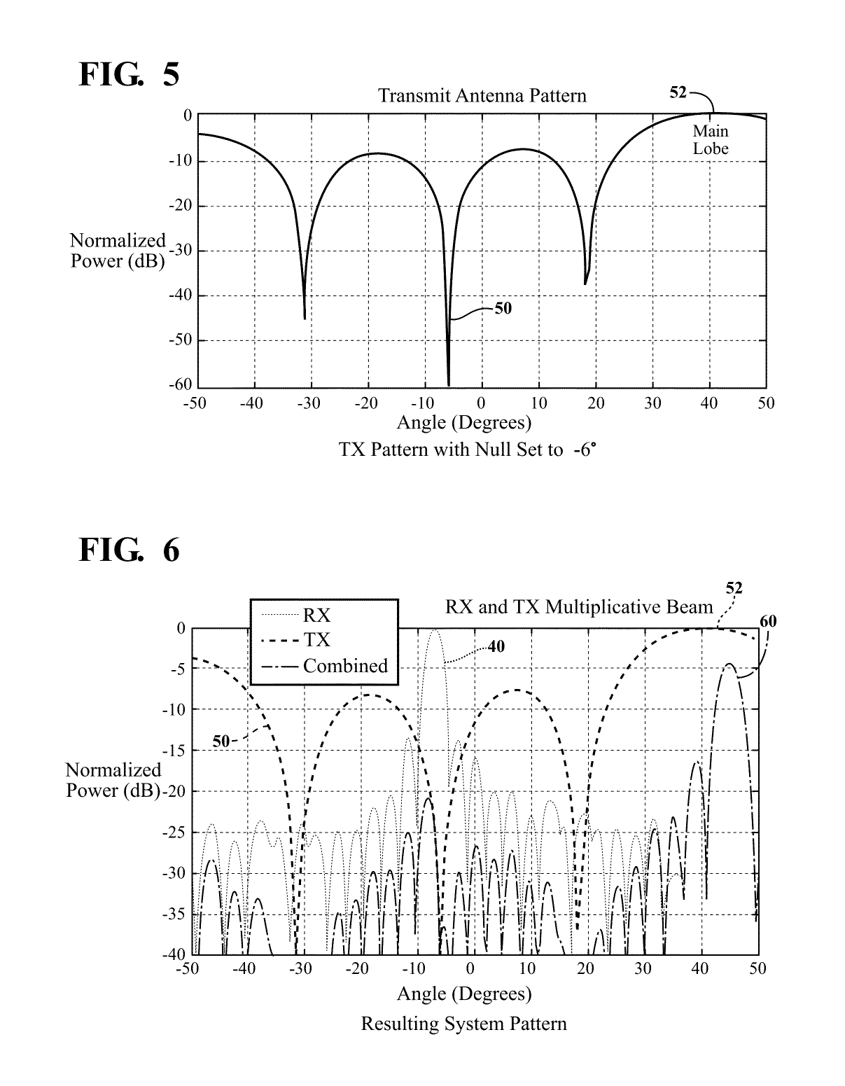

FIG. 5 shows the transmit pattern of the transmit antenna array 50, having a power minimum also at −6 degrees, and a main lobe 52 around 40 degrees. Hence, the transmit antenna pattern has a minimum, effectively a null, at an angle approximately equal to the grating lobe of the receiver antenna array. The transmit beam main lobe is within approximately 5 degrees of the receive beam main lobe, and as the transmit main lobe has a broad maximum, the transmit power along the receive main lobe is many orders of magnitude greater than the transmit power along the grating lobe. The power ratio (transmit power along receive grating lobe/transmit power along receive main lobe) may be −30 dB or less.

FIG. 6 shows the receive pattern 40 (the angular profile of the receive beam), transmit pattern 50, and the resulting system response pattern 60, formed as a product of the transmit and receive patterns. The effect of the grating lobe at 40 is dramatically reduced by the corresponding null in transmit power at a similar angle. In this way, the antenna overall response peaks sharply close to the angle 45 degrees, corresponding to the main lobe 44 of the receive antenna pattern shown in FIG. 4.

As the beams are steered, the illustrated profiles are shifted together along the steering angle axis. However, the general form of the curves are not changed, and the transmit null remains generally aligned with the grating lobe direction.

The transmit antenna element spacing can be adjusted to obtain a desired angular spacing between the main lobe and a power minimum (the null), generally approximately equal to the angular spacing between the receive main lobe and the grating lobe (e.g. within 10° of the latter value). The general form of the transmit and receive antenna patterns can be determined by manufacturing design, e.g. by controlling the receive and transmit antenna element spacings.

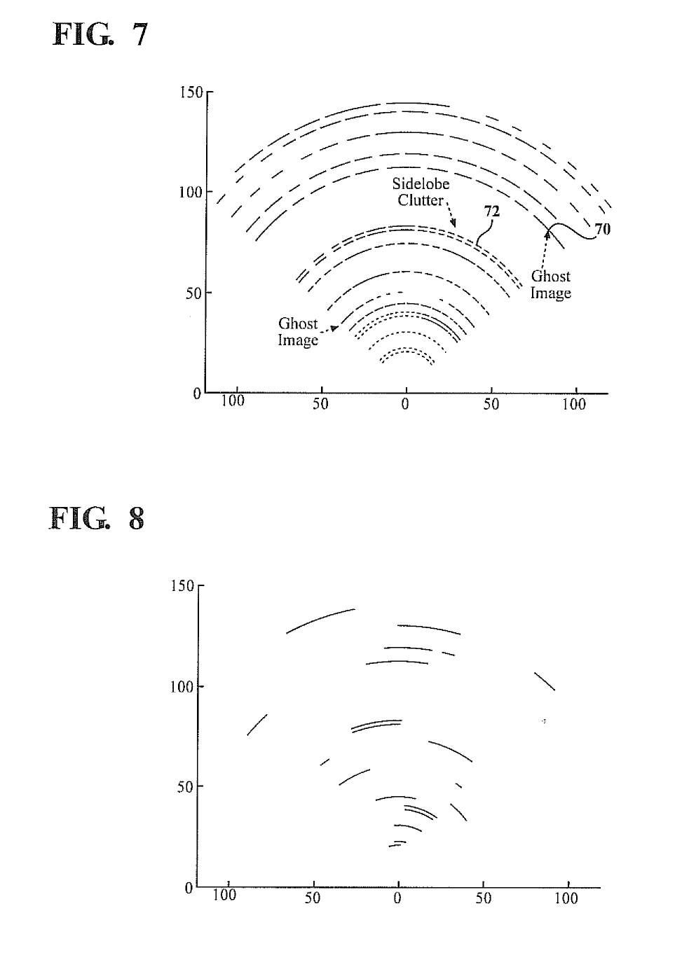

FIG. 7 shows a bird's-eye view of radar return power for an antenna having a receive phased array antenna, and a wide beam transmitter output (e.g. as shown in FIG. 2). There is extensive side lobe clutter, as shown at 72, and ghost images as shown at 70. The side lobe clutter is caused by various side lobes within the receive beam, e.g. the minor response peaks shown in FIG. 4. Ghost targets due to the grating lobe are apparent in the radar output, and the high side lobe levels further clutter the scene.

FIG. 8 shows the response of an antenna having a four-element transmit phased array antenna, and a phased array receive antenna as used in the radar of FIG. 7. Using the phased array approach on both transmit and receive, ghost targets are substantially eliminated, and side lobe clutter is greatly reduced.

In some examples of the present invention, the grating lobe is in the transmit beam and the null is in the receive beam. For example, an antenna may have a steerable transmit antenna generating a transmit beam having a main lobe and a grating lobe, and a steerable receive antenna where the receive beam has a main lobe and at least one null. An electronic control circuit, analogous to others described herein, may then steer the transmit and receive beams so the main lobe of the transmit beam remains generally aligned with the main lobe of the receive beam, and the grating lobe of the transmit beam remains generally aligned with the null in the receive beam. In such examples, the transmit antenna may have more elements than the receive antenna.

The invention is not restricted to the illustrative examples described above. Examples described are exemplary, and are not intended to limit the scope of the invention. Changes therein, other combinations of elements, and other uses will occur to those skilled in the art.

Having described our invention, we claim:

1. An apparatus, the apparatus being a phased array radar apparatus comprising:
a transmit antenna array,
a receive antenna array,
an electronic control circuit, in electronic communication with the transmit antenna array and the receive antenna array,
the transmit antenna array being operable to generate a transmit beam, the transmit beam being steerable by the electronic control circuit,
the receive antenna array being operable to receive the receive beam, the receive beam being steerable by the electronic control circuit,
the receive beam having a receive main lobe and a grating lobe,
the transmit beam having a transmit beam null and a transmit main lobe,
the transmit beam and the receive beam being steerable by the electronic control circuit so the transmit main lobe remains generally aligned with the receive main lobe, and the grating lobe of the receive beam remains generally aligned with the transmit beam null.

2. The apparatus of claim 1, the electronic control circuit including a transmit chip and a receive chip,
the transmit chip steering the transmit beam,
the receive chip steering the receive beam,
the transmit chip and the receive chip being physically separate and electrically connected by a local oscillator feedline.

3. The apparatus of claim 1, the phased array radar having an operating wavelength (λ),
the receive antenna having a receive antenna pitch that is greater than half the operating wavelength.

4. The apparatus of claim 3, the receive antenna pitch being between 0.6 λ and 1.5 λ.

5. The apparatus of claim 1, the receive antenna array having at least four times as many antenna elements than the transmit antenna array.

6. The apparatus of claim 1, the transmit beam and the receive beam being steered by the electronic control circuit so the grating lobe of the receive beam is aligned within 5 degrees of the null in the transmit beam.

7. The apparatus of claim 1, the transmit main lobe being aligned within 10 degrees of the receive main lobe.

8. The apparatus of claim 1,
the null in the transmit beam being at a null angle, a normalized power of the transmit beam at the null angle being less than −30 dB,
the main lobe being centered along a transmit beam direction and having a zero dB normalized power.

9. The apparatus of claim 8, the normalized power of the transmit beam at the null angle being less than −40 dB.

10. The apparatus of claim 1, the transmit chip and the receive chip each including a phased array control, variable gain control, and a mixer.

11. An apparatus, the apparatus being a phased array radar having an operating wavelength, the apparatus comprising:
a transmit antenna array,
a receive antenna array, having a receive antenna pitch greater than half the antenna operating wavelength,
an electronic control circuit, in electronic communication with the transmit antenna array and the receive antenna array, including a transmit chip and a receive chip,
the transmit chip and the receive chip being physically separate and in electrical communication through a local oscillator feedline,
the transmit antenna array generating a transmit beam steerable by the transmit chip,
the receive antenna array receiving the receive beam, the receive beam being steerable by the receive chip,
the receive beam having a receive main lobe and a grating lobe,
the transmit beam having a transmit beam null and a transmit main lobe,
the transmit beam and the receive beam being steered by the electronic control circuit so that the transmit main lobe remains generally aligned with the receive main lobe, and the grating lobe of the receive beam remains generally aligned with the transmit beam null.

12. The apparatus of claim 11, the receive antenna pitch being between 0.7 and 1.5 times the operating wavelength.

13. The apparatus of claim 11, the transmit beam and the receive beam being steered by the electronic control circuit so the side lobe of the receive beam is aligned within 5 degrees of the null in the transmit beam,
the normalized power of the transmit beam at the null being less than −30 dB relative to a peak main lobe power of 0 dB.

14. A method of operating a phased array radar to reduce erroneous detections, the radar being an automotive radar having a field of view, the method including:
providing a steerable transmit antenna, generating a transmit beam having a transmit main lobe and a transmit null;
providing a steerable receive antenna, receiving a receive beam having a receive main lobe and a grating lobe, and
steering the transmit beam and the receive beam across the field of view using an electronic control circuit so the main lobe of the transmit beam is aligned with the main lobe of the receive beam, and the grating lobe of the receive beam is aligned with the transmit null.

15. The method of claim 14, the grating lobe being aligned within 5 degrees of the transmit null as the transmit beam and the receive beam are steered across the field of view.
